(19) United States
(12) Patent Application Publication
(10) Pub. No.: US 2015/0319613 A1
(43) Pub. Date: Nov. 5, 2015

(54) Co-Activation For Authenticating A User's Registration

(71) Applicant: VIBER MEDIA SARL, Luxembourg (LU)

(72) Inventors: Michael Shmilov, Rishon LeZion (IL); Ido Iungelson, Rishon LeZion (IL)

(21) Appl. No.: 14/410,122

(22) PCT Filed: Aug. 18, 2013
(86) PCT No.: PCT/IB2013/056712

§ 371 Date: Dec. 22, 2014

Related U.S. Application Data
(60) Provisional application No. 61/693,258, filed on Aug. 25, 2012.

(51) Int. Cl. H04W 12/06; G06F 21/35

(52) U.S. Cl. CPC H04W 12/06; G06F 21/35

(57) ABSTRACT

A method of authenticating a user's right to a mobile communication device, comprising: providing a service server comprising a database having registered service users entries, each the entries comprising an identification of the service user's mobile communication device, and an identification of the network operator used by the service user's mobile communication device; and requesting by the service server from a client application running on a first mobile communication device to send a SMS message to a client application miming on a second mobile communication device, the first and second mobile communication devices sharing the same network operator.

### CROSS-REFERENCE TO RELATED PATENT APPLICATIONS

This patent application claims priority from and is related to U.S. Provisional Patent Application Ser. No. 61/693,258, filed Aug. 25, 2012, this U.S. Provisional Patent Application incorporated by reference in its entirety herein.

### FIELD OF THE INVENTION

The present invention pertains to the field of authenticating availability of a mobile Communication device to a user registering to a mobile service.

### BACKGROUND

Numerous smartphone applications/services, including Voice or Video Over IP (VVoIP) and/or Instant messaging (IM) applications and others (e.g. Gmail), include a user authentication mechanism based on sending an SMS message to the newly registered user. The authentication SMS message is sent to a phone number provided by the user at registration, to determine whether the user has any right to the phone number. The SMS message may include an authentication code provided to the user by the system.

This mechanism has a drawback as it relies on bulk SMS gateways to deliver the message to the user. These services are not reliable and therefore the message may not be delivered to its destination. For example, network operators often block bulk traffic from a single source.

### SUMMARY

According to a first aspect of the present invention there is provided a method of authenticating a user's right to a mobile communication device, comprising: providing a service server comprising a database having registered service users entries, each said entries comprising an identification of said service user's mobile communication device, and an identification of the network operator used by said service user's mobile communication device; and requesting by said service server from a client application running on a first mobile communication device to send a SMS message to a client application running on a second mobile communication device, said first and second mobile communication devices sharing the same network operator.

The SMS message may comprise a registration authentication code to said service.

The method may further comprise sending by said first user client application said requested SMS message to said second user mobile communication device.

The database entries may further comprise a number of free SMS messages to be sent from each of said users' mobile communication devices; and the method may further comprise reducing by said service server the number of free SMS messages in said first user's database entry.

According to a second aspect of the present invention there is provided a system for authenticating a user's right to a mobile communication device, comprising: a service server comprising a database having registered service users entries, each said entries comprising an identification of said service user's mobile communication device and an identification of the network operator used by said service user's mobile communication device; and a plurality of user mobile communication devices running a client application, said client application communicating bi-directionally over the internet with said server application; said server application configured to send a request to said client application running on a first mobile communication device to send a SMS message to another client application running on a second mobile communication device, said first and second mobile communication devices sharing the same network operator.

The SMS message may comprise a registration authentication code to said service.

The database entries further may comprise a number of free SMS messages to be sent from each of said users' mobile communication devices.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic drawing of the system component for carrying out the present invention;

FIG. 2 is a schematic drawing of the data flow according to the present invention; and

FIG. 3 is a flowchart showing the various steps according to the present invention.

### DETAILED DESCRIPTION OF PREFERRED EMBODIMENTS

The present invention provides a solution to the drawbacks of existing smartphone applications/services authentication systems.

SMS messages have a very high delivery rate when sent by an end-user and especially when sent within the same network. In addition, these SMS messages are usually cheap or even free (e.g. SMS from one AT&T subscriber to another).

When a user registers to a smartphone application requiring authentication, the client application can report to which mobile network it is connected. This information may include, for example, the Mobile Country Code (MCC) and Mobile Network Code (MNC). In GSM networks the SIM card installed on the device reports this. Alternatively, a lookup service can be used to match the network for a given number, for example in cases where the operator network may be identified by the area code, etc.

In other cases, the home location register (HLR) may be used for identifying the network operator, using a service such as, for example, Infobip's HLR Lookup (http://www.infobip.com/services/hlr).

After registration to a service (e.g. VoIP or IM service), a smartphone user may be asked whether she would allow for a limited number of free SMS messages to be sent from her device. If she agrees, information about her device is entered into a central database entry containing for example information about the mobile operator (e.g. MCC/MNC), the unique device's ID in the service, and a number of SMS messages that the service is allowed to send using the user's device. For example:

| MCC | MNC | Device ID | Phone | Credit |
|---|---|---|---|---|
| 310 | 410 | XXX | 1212555222 | 10 |

When a user wants to register a new device, the service identifies the network (i.e. operator or carrier) by one of the methods above or by asking the user for the required information.

The service now looks up a database entry that matches the new registration's network, namely a device having the same operator. If it finds such an entry (with some credit left), it will send a message to the application running on that device e.g. “send an SMS to 12125551222 with code 1234”. When the application receives this message, it will send an SMS as requested and will notify the service that the SMS had been sent. When the service receives this notification it will decrease the credits for that device. If no credits are left, the record will be removed from the central database.

Thus, the service has used available resources of a network to increase the probability of a safe registration to the service of a new device.

If the application isn't currently running on the approached device, or the service does not receive an acknowledgement that the SMS was sent to the newly registered device, it can either look for another device to send the message—or fall back to using a gateway service as before.

In addition, this method may be enabled only for specific networks based on various Criteria—for example, if indeed the delivery rate is low and/or it costs nothing to the users to send SMS messages within the same network.

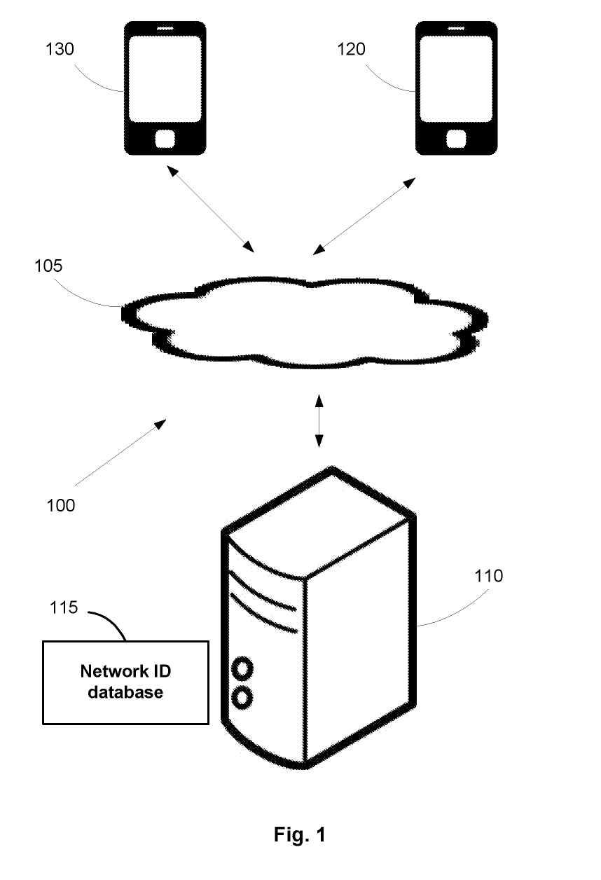

FIG. 1 is a schematic drawing of the system component for carrying out the present invention.

System 100 comprises a plurality of clients 120, 130 running on users' smartphones, and a server 110 communicating bi-directionally with the clients over a network 105 such as the internet.

The server stores a database 115 of network identification for each of the clients, as explained above.

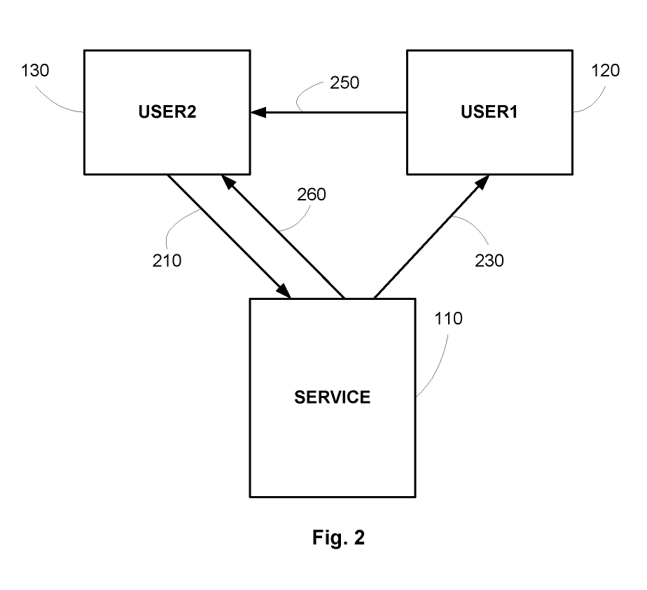

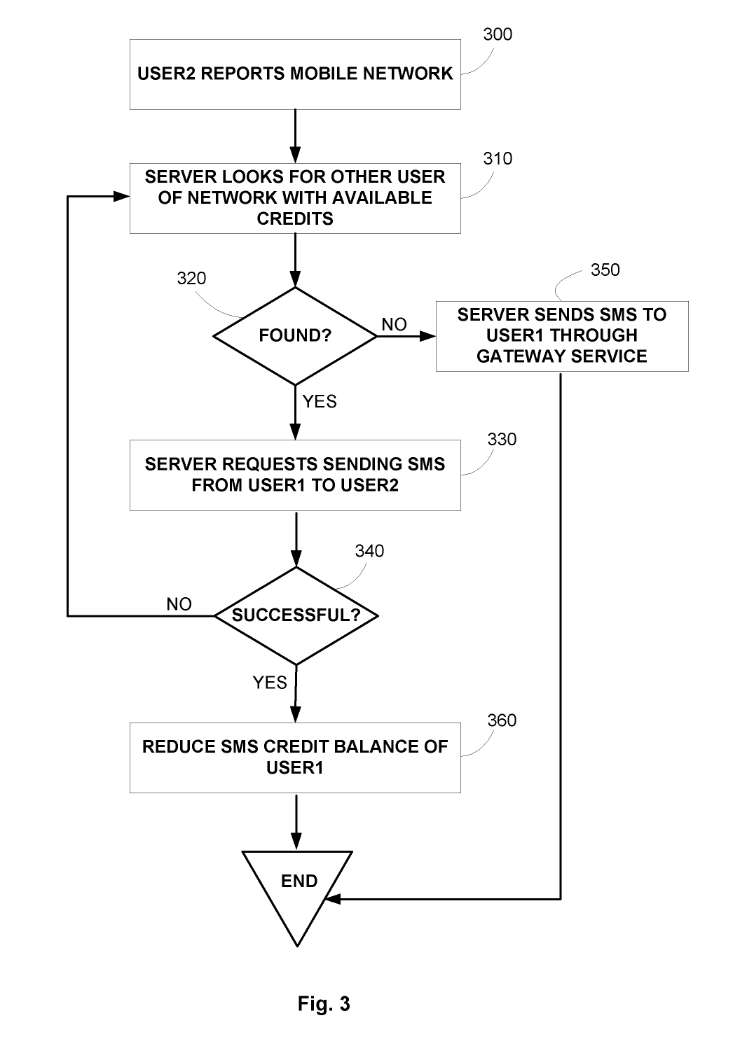

Attention is drawn now to FIG. 2, a schematic drawing of the data flow according to the present invention and to FIG. 3, a flowchart showing the various steps according to the present invention.

It is assumed that User1 120 is a service user and that User1 120 and User2 130 use the same mobile network operator.

In step 300 User2 130 has just subscribed to the service and her client application reports 210 to the system server 110 its mobile network operator, as described above.

In step 310 the server 110 looks in its database 115 for another user of the reported network, having available SMS credits.

If such a user is found (User1 120) in step 320, the server requests 230 User1 client application to send 250 an authentication SMS message (step 330) to User2 130, to finalize User2's process of enrollment to the service.

If User1 reports successful completion (step 340), the server reduces the number of available SMS credits in User1's database entry (step 360).

Otherwise, if no other user connected to the same network operator is found having credit SMS messages, the system server resorts to the fallback scenario of sending 260 a SMS message to User2 via a gateway service (step 350).

It will be understood by persons skilled in the art that the invention is not limited to the examples provided. For example, using available network resources is not limited to the application of registration authentication and may be used for any other purpose requiring a large number of messages to be transmitted. Also, the free messages counter is not mandatory to the invention, for example, in networks having free message communication between their users.

It will be understood by persons skilled in the art that the invention is not limited to smartphones. Rather the invention may be applied to any mobile communication device capable of sending and receiving SMS messages.

1. A method of authenticating a user's right to a mobile communication device, comprising:
providing a service server comprising a database having registered service users entries, each said entries comprising an identification of said service user's mobile communication device, and an identification of the network operator used by said service user's mobile communication device; and
requesting by said service server from a client application running on a first mobile communication device to send a SMS message to a client application running on a second mobile communication device, said first and second mobile communication devices sharing the same network operator.

2. The method of claim 1, wherein said SMS message comprises a registration authentication code to said service.

3. The method of claim 1, further comprising
sending by said first user client application said requested SMS message to said second user mobile communication device.

4. The method of claim 3, wherein said database entries further comprise a count of SMS messages to be sent from each of said users' mobile communication devices; and
said method further comprising
reducing said count by said service server.

5. A system for authenticating a user's right to a mobile communication device, comprising:
a service server running a server application, said service server comprising a database having registered service users entries, each said entries comprising an identification of said service user's mobile communication device and an identification of the network operator used by said service user's mobile communication device; and
a plurality of user mobile communication devices running a client application, said client application communicating bi-directionally over the internet with said server application;
said server application configured to send a request to said client application running on a first mobile communication device to send a SMS message to another client application running on a second mobile communication device, said first and second mobile communication devices sharing the same network operator.

6. The system of claim 5, wherein said SMS message comprises a registration authentication code to said service.

7. The system of claim 5, wherein said database entries further comprise a count of SMS messages to be sent from each of said users' mobile communication devices.
